(19) United States
(12) Patent Application Publication
(10) Pub. No.: US 2020/0309041 A1
(43) Pub. Date: Oct. 1, 2020

(54) HYDRAULICALLY-ACTUATED FUEL DELIVERY TIMING ADVANCE MECHANISM FOR DIESEL ENGINES WITH MECHANICAL FUEL INJECTION PUMPS

(71) Applicant: Von D. Rosquist, Levan, UT (US)

(72) Inventor: Von D. Rosquist, Levan, UT (US)

(21) Appl. No.: 16/365,656

(22) Filed: Mar. 26, 2019

(51) Int. Cl. F02D 1/18; F02D 1/16

(52) U.S. Cl. CPC F02D 1/183; F02D 1/162

(57) ABSTRACT

A variable timing apparatus, for an internal combustion engine equipped with a mechanical fuel injection pump, includes a tubular extender having a front flange bolted to the normal injection pump mount and a rear mounting flange bolted to the injector pump. The timing drive shaft is equipped with a male right-hand helically-splined drive. The injection pump drive is equipped with a left-hand helically-splined drive. A spring-biased, slidable coupler has a front end right-hand helically-splined socket that engages the male right-hand drive, and a rear end left-hand helically-splined socket that engages the male left-hand drive on the injector pump. After engine startup, oil pressure moves the sliding coupler axially rearward and rotates clockwise with respect to and as seen from the timing drive shaft. The injection pump drive also rotates clockwise, with respect to the coupler, thereby advancing injection timing.

### FIELD OF THE INVENTION

This invention relates, generally, to combustion timing adjustment mechanisms for internal combustion engines and, more particularly, to hydraulically-actuated timing adjustment mechanisms for diesel engines.

### BACKGROUND OF THE INVENTION

Fuel delivery and spark timing in a conventional internal combustion engine is generally specified in rotational degrees of the crankshaft either before or after the top dead center position of a connecting rod journal of the crankshaft and its associated piston at the end of the compression stroke. In a fuel injection type of internal combustion engine, the combustion characteristics are, in part, determined by the injection timing. In a typical prior art four-stroke-cycle engine, fuel injection is initiated between approximately 35 degrees and 5 degrees before top dead center (BTDC). When the timing is advanced (closer to 35 degrees BTDC), more time is allotted for the combustion process, which results in more complete combustion of the injected fuel, greater fuel efficiency and a reduction in unburned hydrocarbon emissions. However, advanced timing produces significantly higher combustion pressures, as well as significantly higher combustion temperatures, which result in increased nitrogen oxide (NO2) emissions, except at low engine loads when relatively little fuel is being burned. In addition, because of the increased combustion pressures, advanced timing may make an engine much more difficult to start. On the other hand, when the timing is retarded (closer to 5 degrees BTDC), the NO2 emissions are reduced because most combustion occurs after the piston reaches top dead center. However, because less time is allocated for the combustion process, the emission of unburned hydrocarbons is increased.

The timing that is selected for normal operation of an internal combustion engine is generally a compromise that produces acceptably low quantities of both hydrocarbon and NO2 emissions.

U.S. Pat. No. 3,951,117 and U.S. Pat. No. 4,134,549, both of which issued to Julius P. Perr, disclose a fuel supply system including means for varying the timing of the initiation of injection of the fuel, and the timing may be varied through an infinite number of steps. The injectors disclosed in the above patent and application operate such that injection is terminated when a moving member moves past and opens a spill port. This method of terminating injection has the disadvantages that injection pressure is lost as soon as the spill port is opened, and that the time of termination of injection cannot easily be adjusted.

U.S. Pat. No. 4,142,498 to James T. Hammond discloses a manually-adjustable timing advance mechanism for internal combustion engines, including a driven shaft having cams thereon for actuating a fuel pump for internal combustion engines, a driving shaft adapted to be driven by an engine proportionally to engine speed, the shafts having aligned, splined ends in close adjacency with the lead of the splines on the ends being dissimilar. A splined coupling interconnects the ends and is axially movable thereon and rotatable with the shafts. A collar rotatably receives the coupling and restrains the coupling against axial movement. An adjusting mechanism including a manually and selectively operable actuator is provided for axially adjusting the position of the collar and for holding the collar in a desired position of adjustment. By reason of the dissimilar lead between the splines, movement of the collar, and thus the coupling, will change the angular relationship between the two shafts so that precise timing can be achieved without disassembling the mechanism.

U.S. Pat. No. 4,249,499, also issued to Julius P. Pen, discloses an apparatus, for use with an injector, that includes a movable plunger and a cam drive for the plunger. The apparatus includes movable pistons connected between the cam drive and the plunger, the pistons forming a timing chamber therebetween. A volume of timing fluid is fed into the timing chamber and forms a hydraulic link between the pistons, the timing fluid volume determining the length of the link and the time of initiation of injection. The apparatus further includes a pressure release valve for releasing at least a portion of the timing fluid volume when the pressure in the timing chamber is above a predetermined level. In one form of the invention, the timing is adjustable through many steps, and in another form of the invention the timing is adjustable between two steps.

### SUMMARY OF THE INVENTION

The present invention provides a variable timing apparatus installable on a compression ignition (diesel) internal combustion engine that is equipped with: an engine oil pump that provides pressurized engine oil for pressurized lubrication of moving engine components; a timing drive that, if the engine employs a two-stroke cycle, rotates at the speed of the crankshaft, or, if the engine employs a four-stroke cycle, rotates at half the speed of the crankshaft; a conventional mechanical fuel injection pump with a straight-splined drive, the body of the fuel injection pump being secured to the normal injection pump mount and the straight-splined drive being coupled to the engine's timing drive with a straight-splined coupler. To implement the invention, the straight-spline drive on the injector pump drive shaft is replaced by a left-hand helical splined drive. A hydraulically-actuated link between the engine timing drive and the fuel injection pump drive is provided. The link provides an injection timing advance when pressurized engine oil is supplied to the link after engine startup. The device utilizes two sets of helically-splined connectors. One set comprises right-hand helically-splined connector elements, while the other set comprises left-hand helically-splined connector elements.

The hydraulically-actuated link apparatus includes a tubular extender equipped with front and rear mounting flanges at opposite ends. A front mounting flange of a tubular extender bolts to the normal injection pump mount, whether it be on the engine block, itself, or on a an injection pump drive housing; the injector pump bolts to a rear mounting flange of the tubular extender. The tubular extender houses a slidable coupler that is directly coupled both to the timing drive of the engine and to the injection pump. Typically, the timing drive is either a gear or sprocket that is coupled to the engine crankshaft. On a four-stroke-cycle engine, the timing drive rotates at half the speed of the crankshaft. On a two-stroke-cycle engine, the timing drive rotates at the same speed as the crankshaft. For an engine which rotates in a clockwise direction as viewed from the rear, or output, end thereof, the drive end of the engine timing drive shaft is equipped with a right-hand helical splines. As heretofore stated, the standard straight-splined drive on the injection pump is replaced with a left-hand helically-splined drive. A slidable coupler, having a front socket equipped with right-hand internal helical splines that mate with the right-hand helical splines of the drive end of the timing drive shaft and a rear end socket equipped with left-hand internal helical splines that mate with the left-hand external helical splines of the injection pump drive. The slidable coupler is equipped with an internal wall that separates the right-hand helically-splined portion from the left-hand helically-splined portion. A coil spring, inserted within the slidable coupler between the injection pump drive and the internal wall, urges the slidable coupler to a normally-retarded timing position. At engine startup, when there is little or no oil pressure flowing to the engines bearings, the sliding coupler is in the normally-retarded timing position. When the engine starts and the engine is running at idle speed, oil pressure is sufficient to overcome pressure of the spring within the sliding coupler, thereby moving the sliding coupler axially rearward approximately 1.0 cm. As the sliding coupler travels axially rearward, it rotates approximately 20 degrees in a counterclockwise direction and causes the injection pump drive to rotate an additional 20 degrees in a counterclockwise direction as the coupler slides over it, thereby advancing injection timing by a total of 40 degrees.

### BRIEF DESCRIPTION OF THE DRAWINGS

FIG. 1 is an exploded view of the timing drive shaft, the slidable coupler (in cross-sectional format) and the injection pump drive shaft;

FIG. 2 is a front elevational view of the timing drive shaft, showing the timing gear mounting flange and the hidden oil galleys;

FIG. 3 is a rear elevational view of the slidable coupler;

FIG. 4 is a front view of the splined injection pump drive;

FIG. 5 is an exploded view of the timing drive shaft, the slidable coupler and the injection pump drive shaft, as in FIG. 1, but with the timing gear mounting flange surrounded by a journal bearing (in cross-sectional format), a thin washer-like spacer and a timing gear affixed to the timing gear mounting flange with allen bolts and an annular spacer sandwiched between the heads of the alien bolts and a roller bearing assembly;

FIG. 6 is a cross-sectional view of the journal bearing in which the timing gear flange spins;

FIG. 7 is an assembled view of the components of FIG. 5;

FIG. 8 is a rear view of the helically-splined injection pump drive installed within the slidable coupler; and

FIG. 9 is an assembled side elevational view of the entire timing assembly, including a timing gear cover, a tubular extender (in cross-sectional format), and a Stanadyne DB2 fuel injection pump (in profile format).

### PREFERRED EMBODIMENT OF THE INVENTION

The invention will now be described with reference to the attached drawing figures. It should be understood that the drawing figures may not be to scale, and are intended to be merely representative of the invention. Though the invention is illustrated in the context of a Navistar 6.9/7.31 V8 diesel engine equipped with a Stanadyne DB2 fuel injection pump, the invention can be applied to many other compression-ignition (diesel) engines which employ mechanical injection pumps.

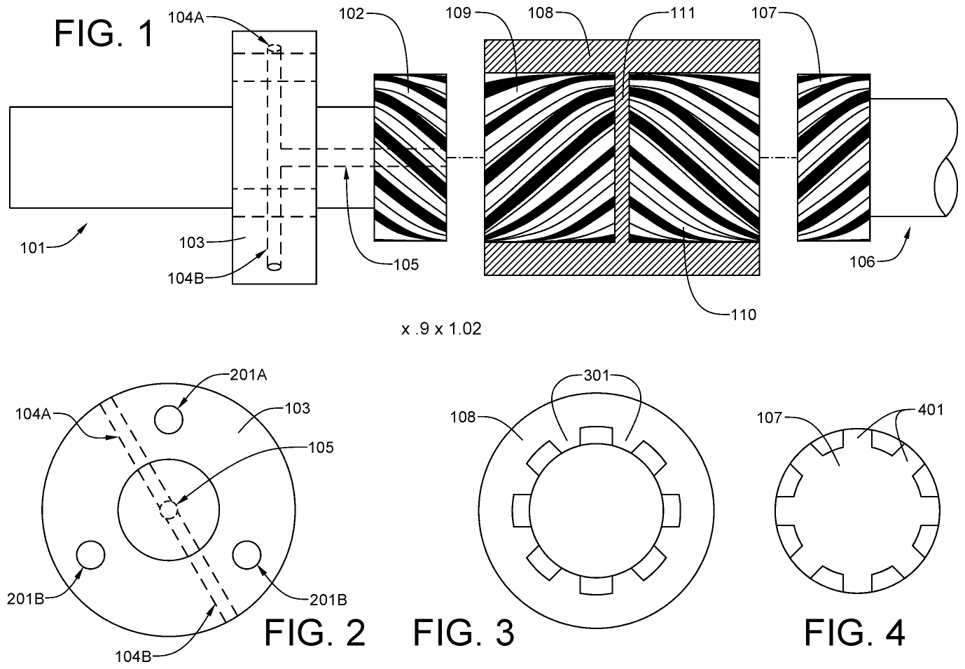

Referring now to FIG. 1, the timing drive shaft 101, on the left, is equipped with a male right-hand helically-splined drive 102 and a timing gear mounting flange 103. The timing gear mounting flange 103 is equipped with radial oil galleys 104A and 104B, which connect with an axial oil galley 105 in the timing drive shaft 101. A standard straight-splined drive (not shown) on the injection pump drive shaft 106, on the right, has been replaced with a left-hand helically-splined drive 107. The slidable coupler 108, which is shown in cross-sectional format, incorporates a female, right-hand helically-splined socket 109, into which the male helically-splined drive 102 helically slides, and a female, left-hand helically-splined socket 110, into which the male left-hand helically-splined drive 107 slides. The two splined sockets 109 and 110 of the slidable coupler 108 are separated by a wall 111. The drawings are complex. External splines can be thought of as a series of walls machined into the surface of a cylindrical object, while internal splines are analogous to a series of walls machined into the surface of a cylindrical cavity. Helical splines are like a series of curving spiral walls, while straight splines are like a series of straight, radially-spaced walls. For the sake of clarification, the top surface of each visible spline or wall is shown as a black-hatched area for both external and internal splines. Thus, the top of each black outer spline wall will be sliding in a groove between black-topped inner spline walls.

It will be noted that FIGS. 1, 5 and 7 are difficult to visualize, as the slidable coupler 108 is shown in cross-sectional format, while the male right-hand helically-splined drive 102 and the left-hand helically-splined drive 107 are shown in elevational format.

Referring now to FIG. 2, this front view of the timing drive shaft 101 shows the gear mounting flange 103 and the hidden radial oil galleys 104A/104B and the axial oil galley 105. Also shown are three threaded bolt holes 201A, 201B and 201C, which are employed to secure a timing gear to the timing gear mounting flange 103.

Referring now to FIG. 3, this end view of the female, straight-splined socket 110 of the slidable coupler 108 shows the profile of the straight splines 301.

Referring now to FIG. 4, this end view of the male, straight-splined drive 107 shows the profile of the straight splines 401.

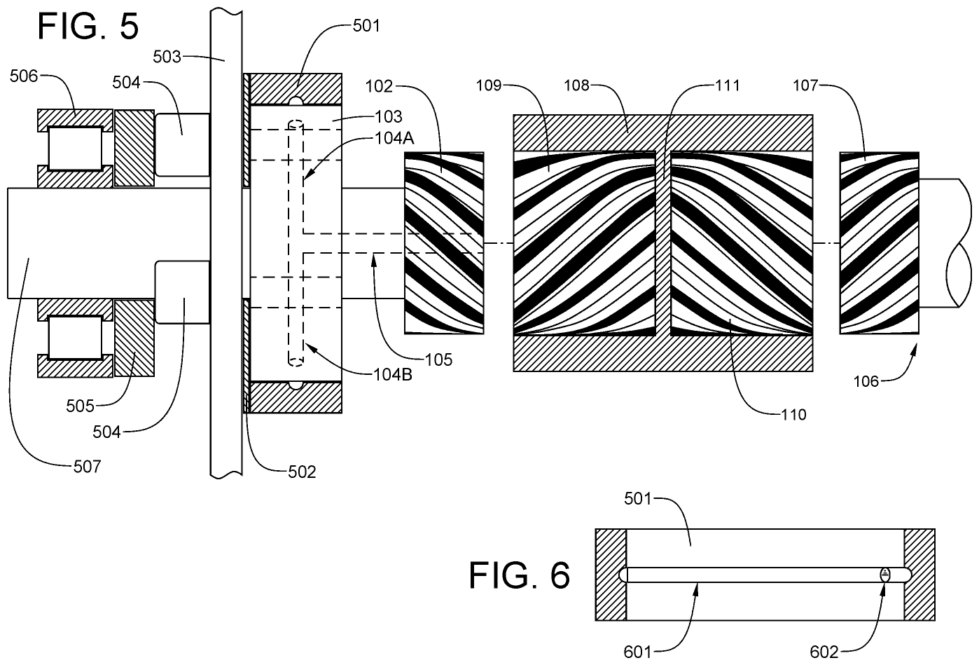

Referring now to FIG. 5, this exploded view of components is identical to that of FIG. 1, but with the timing drive shaft 101 built up to include a journal bearing 501 that surrounds the timing gear mounting flange 103, a thin washer-like spacer 502 and a timing gear 503 (only the central portion is shown) bolted to the timing gear mounting flange 103 with allen bolts 504 (only two of three are shown in this view), an annular spacer 505 sandwiched between the heads of the allen bolts 504 and a roller bearing assembly 506 that slides onto the left end 507 of the timing drive shaft 101.

Referring now to FIG. 6, this cross-sectional view of the journal bearing 501 shows the central oil supply groove 601, as well as the oil supply aperture 602, that will be coupled to a pressurized oil galley in the block.

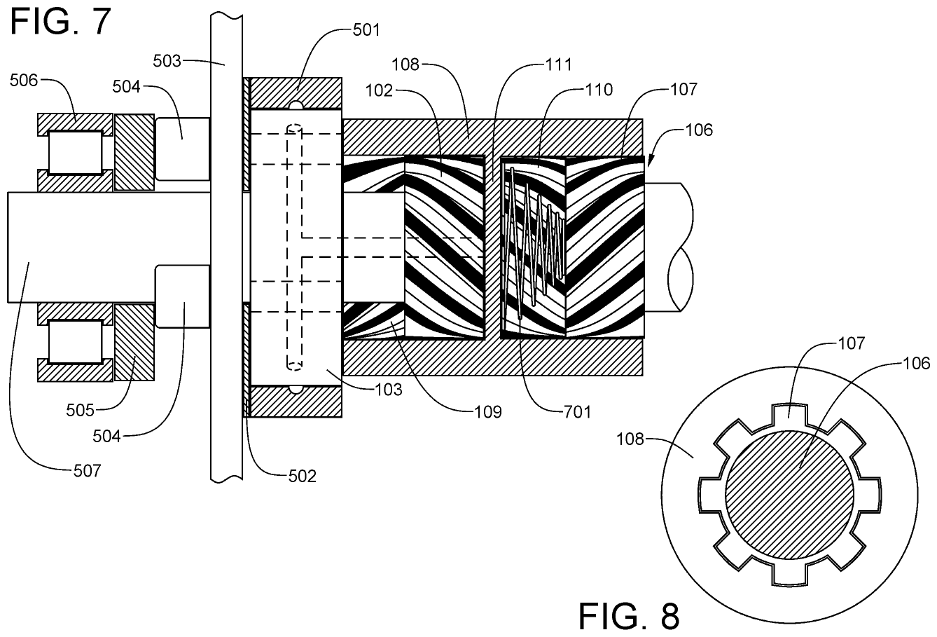

Referring now to FIG. 7, the components of FIG. 5 have been assembled by inserting the male right-hand helically-splined drive 102 into the female, right-hand helically-splined socket 109 and the male left-hand helically-splined drive 107 into the female left-hand helically-splined socket 110. It will be noted that a tapered coil spring 701 has been inserted between the wall 111 and the male straight-splined drive 107. This spring 701 returns the slidable coupler 108 to its original position, once the equipped engine is shut down and the oil pressure drops to zero. It should be noted that the radial oil galleys 104A/104B and the axial oil galley 105 enable oil provided to the outer periphery 112 of the timing gear mounting flange 103 to pressurize the chamber 702 formed between the wall 111 and the male helically-splined drive 102.

Referring now to FIG. 8, this view shows the male straight-splined drive 107 installed within the female, straight-splined socket 110 of the slidable coupler 108.

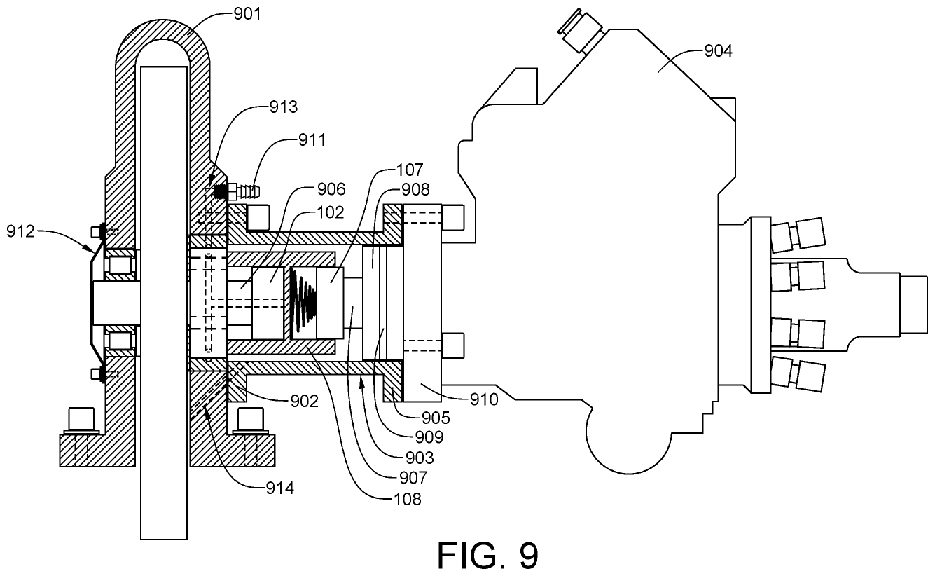

Referring now to FIG. 9, the assembly of FIG. 7 has been installed within the timing gear housing 901 of a Navistar 6.9/7.31 V8 diesel engine. The front flange 902 of a tubular extender 903 has been bolted to the rear of the timing gear housing 901 and a Stanadyne DB2 fuel injection pump 904 has been bolted to the rear flange 905 of the tubular extender 903 after the straight-splined drive 107 of the fuel injection pump 904 has been rotationally adjusted for proper injection timing at engine startup. It should be understood that the front flange 902 of the tubular extender 903 is bolted to what was, originally, the mounting location for the fuel injection pump at the rear of the timing gear housing 901. The timing gear housing 103 will also be referred to as the timing drive housing, as on other types of engines, the timing drive may be chain driven rather than gear driven (as on the Navistar V8 diesel engines). This shall also be referred to as the normal fuel injection pump mount. The tubular extender 903 encloses the rear end 906 of the timing drive shaft 101, the male right-hand helically-splined drive 102 that is attached to the rear end 906 of the timing drive shaft 101, the sliding coupler 108, the male left-hand helically-splined drive 107, the front end 907 of the injection pump drive shaft 106, and the nose 908 of the fuel injection pump 904. It will be noted that the nose 908 is equipped with a sealing O-ring 909, which prevents leakage of oil at the joint between the rear flange 905 of the tubular extender 903 and the fuel injection pump mounting flange 910. It will be noted that a barbed oil fitting 911 has been threadably secured to the timing gear housing 901. This oil fitting 911 will be connected to a high-pressure oil line or hose that is connected to a pressurized oil galley of the Navistar engine. A cover plate 912 seals an inspection hole on the front of the timing gear housing 901 and also locates the front end of the timing drive shaft 101. Through the timing gear cover oil galley 913, the oil supply aperture in the journal sleeve bearing 501, the radial oil galleys 104A/104B and axial oil galley 105 in the timing drive shaft 101, oil is supplied to the chamber 702 formed between the wall 111 and the male helically-splined drive 102. When the engine starts and the engine is running at idle speed, oil pressure is sufficient to overcome pressure of the spring 701, thereby moving the sliding coupler 108 axially rearward approximately 1.0 cm. As the sliding coupler 108 travels axially rearward, it rotates approximately 20 degrees in a counterclockwise direction (as seen from the location of the injection pump and causes the injection pump left-hand drive 107 to rotate an additional 20 degrees, also in a counterclockwise direction as the coupler slides over it, thereby advancing injection timing by a total of 40 degrees thereby advancing injection timing by the same amount. An oil return galley 914 allows oil pumped into the tubular extender 903 to be returned to the engine oil sump (not shown).

Although only a single embodiment of the hydraulically-actuated timing advance mechanism for compression-ignition (diesel) engines with mechanical fuel injection pumps is shown and described, it will be obvious to those having ordinary skill in the art that changes and modifications may be made thereto without departing from the scope and the spirit of the invention as hereinafter claimed.

What is claimed is:

1. In combination with a compression-ignition internal combustion engine having a timing drive equipped with a timing drive shaft equipped with a first straight-splined male drive, a conventional injection pump mount adjacent the first straight-splined male drive, a mechanical fuel injection pump having a second straight-splined male drive rotatably secured to the injection pump, and a straight-splined female coupler which couples the first straight-splined male drive to the second straight-splined male drive, and an oil pump which provides pressurized lubrication of engine components when the engine is operational, an apparatus for advancing injection timing following engine startup, said apparatus comprising:
a tubular extender having a front flange securable to the injection pump mount, and a rear mounting flange to which the injection pump is securable;
a replacement timing drive shaft having a right-hand helically-splined male drive;
a left-hand helically-splined male drive rotatably secured to the fuel injection pump, said left-hand drive replacing the second straight-spline drive of the fuel injection pump; and
a slidable female coupler, spring-biased away from the injection pump, having a front-end socket equipped with internal right-hand helical splines that slidably engage the helical splines of the right-hand male drive, and a rear-end socket equipped with internal left-hand helical splines that slidably engage the helical splines of the left-hand male drive affixed to the fuel injection pump, said slidable coupler being urged rearward, toward the injection pump, by oil under pressure provided by the oil pump when the engine is operating, thereby overcoming the spring biasing and advancing injection timing as the slidable coupler rotates counterclockwise, as seen from the injection pump, with respect to the right-hand helically-splined male drive gear and the left-hand helically-splined drive gear also rotates counterclockwise with respect to the slidable female coupler.

2. The combination of claim 1, wherein rearward movement of the slidable coupler is about 1.0 cm.

3. The combination of claim 1, wherein rotational movement of the slidable coupler, with respect to the right-hand male drive, during its rearward travel is about 20 degrees, and the rotational movement of the left-hand male drive, with respect to the slidable coupler is also about 20 degrees, for a total timing advance of 40 degrees.

4. The combination of claim 1 wherein a rearward movement of about 1.0 cm by the slidable coupler results in a timing advance of about 40 degrees.

5. A method for advancing injection timing of a compression-ignition internal combustion engine following engine startup, said engine having a timing drive shaft equipped with a first straight-splined male drive, a conventional injection pump mount adjacent the first straight-splined male drive, a mechanical fuel injection pump having a second straight-splined male drive rotatably secured to the injection pump, and coupled to the first straight-splined male drive with a straight-splined female coupler, and an oil pump for pressurized lubrication of engine components when the engine is operational, said method comprising the steps of:
replacing the timing drive shaft having a first straight-splined male drive with one having a right-hand helically-splined male drive;
providing a path for pressurized engine oil to reach a free end of said right-hand male drive;
providing a tubular extender having a front flange securable to the injection pump mount, and a rear mounting flange to which the injection pump is securable;
replacing the second straight-splined drive with a left-hand helically-splined male drive;
providing a slidable female coupler having a first end equipped with a socket with right-hand internal helical splines that slidably engage the helical splines of the right-hand male drive, and a second end equipped with a socket with left-hand internal helical splines that slidably engage the helical splines of the left-hand male drive;
installing said slidable coupler within said tubular extender so that the right-hand female helical splines engage the male right-hand helical splines of the timing drive shaft;
installing a coil spring within the socket of said second end;
rotationally adjusting the left-hand helically-splined drive of the fuel injection pump to set pump timing;
engaging the left-hand male helical splines of the pump drive with the left-hand female helical splines of the slidable coupler; and
securing the fuel injection pump to the rear flange of the tubular extender.

6. The method of claim 5, wherein pressurized oil exiting free end of the right-hand male drive gear causes the slidable coupler to move rearward after engine startup, thereby causing the slidable coupler to rotate counterclockwise, as viewed from the timing pump, and with respect to the right-hand timing drive gear, and the left-hand, helically-splined pump drive to rotate counterclockwise with respect to the slidable coupler, thereby advancing injection pump timing.

7. The method of claim 5, wherein injection timing is advanced about 40 degrees.

8. The method of claim 5, wherein the slidable coupler is moved rearward about 1.0 cm.

9. The method of claim 5, wherein pressurized oil exiting said right-hand drive causes the slidable coupler to move rearward about 1.0 cm after engine startup, thereby causing rotational movement of the slidable coupler of about 20 degrees, with respect to the right-hand male drive gear, as well as rotational movement of the left-hand male drive of about 20 degrees, with respect to the slidable coupler, for a total timing advance of 40 degrees.

10. The method of claim 5, wherein said path for pressurized oil passes through a timing drive housing, though a journal sleeve bearing, and into the timing drive shaft, which is axially drilled for oil flow.

11. The method of claim 10, wherein oil to the timing drive housing is fed by an oil line that is connected to an engine oil galley.

12. A method for advancing injection timing of a compression-ignition internal combustion engine following engine startup, said engine having a mechanical fuel injection pump with a straight-splined drive, a normal injection pump mount, a timing drive shaft, and an oil pump for providing pressurized engine oil for pressurized lubrication of engine components when the engine is operational, said method comprising the steps of:
providing a hydraulically-actuated link between the engine timing drive and the fuel injection pump drive, said link having a pair of opposite-handed, male helically-splined drives secured to the timing drive and to the pump drive and a spring-biased sliding female coupler that engages the splines of both male drives; and
providing a path for pressurized engine oil to reach said hydraulically-actuated link so that engine oil pressure can overcome the spring biasing and move the coupler both linearly and rotatably about a central axis to advance injection timing after engine startup.

13. The method of claim 12, wherein said hydraulically-actuated link includes a right-hand, helically-splined male drive mounted on the engine timing drive shaft, a left-hand, helically-splined male drive rotatably mounted on the injection pump drive shaft, and a slidable coupler having a right-hand helically-splined socket that engages the right-hand male gear and a left-hand helically-splined socket that engages the left-hand male drive, said coupler having a wall between the two sockets, and a coil spring installed between the wall and the left-hand drive mounted on the injection pump.

14. The method of claim 12, wherein injection timing is advanced about 20 degrees for each male and female spline set, for total advance of about 40 degrees.

15. The method of claim 13, wherein the slidable coupler is moved rearward a total of about 1.0 cm as injection timing is advanced about 40 degrees.

16. The method of claim 13, wherein pressurized oil provided to the hydraulically-actuated link causes the slidable coupler to move rearward about 1.0 cm after engine startup, thereby causing the slidable coupler to rotate counterclockwise about 20 degrees, as viewed from the injection pump, and the left-hand male gear to rotate counterclockwise about 20 degrees, with respect to the coupler.

17. The method of claim 12, wherein said path for pressurized oil passes through a timing drive housing, though a journal sleeve bearing, and into the timing drive shaft, which is axially drilled for oil flow.

18. The method of claim 17, wherein oil to the timing drive housing is fed by an oil line that is connected to an engine oil galley.
